(19) United States
(12) Patent Application Publication
(10) Pub. No.: US 2009/0248531 A1
(43) Pub. Date: Oct. 1, 2009

(54) Automatic payment calculator unit for purchasing goods

(76) Inventor: Moon-Key Han, Seoul (KR)

Correspondence Address: ROBERT E. BUSHNELL & LAW FIRM, 2029 K STREET NW, SUITE 600, WASHINGTON, DC, 20006-1004, US

(21) Appl. No.: 10/593,040

(22) PCT Filed: Mar. 16, 2005
(86) PCT No.: PCT/KR05/00734

§ 371 Date: Sep. 15, 2006

(30) Foreign Application Priority Data
Mar. 16, 2004 (KR) 20-2004-0007159

(51) Int. Cl. G06Q 30/00; G06Q 20/00

(52) U.S. Cl. 705/17; 186/61; 705/23

(57) ABSTRACT

The present invention relates to an automatic payment calculator unit, which enables a purchaser in a large shop to calculate a price of articles and pay for the price in person so that the shop may be operated without an accounting clerk.

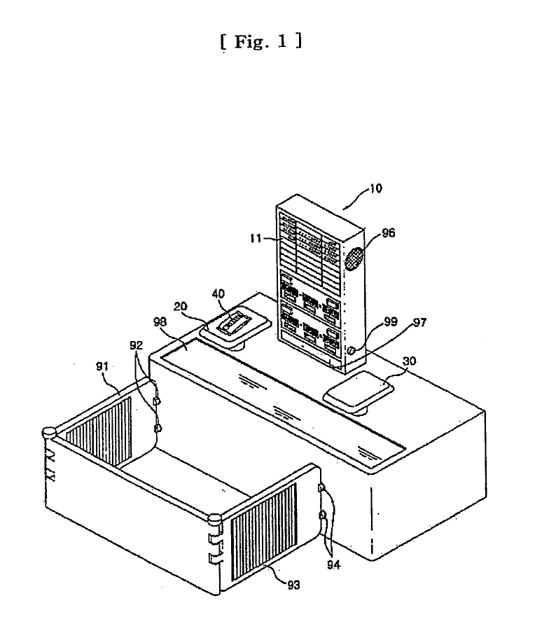

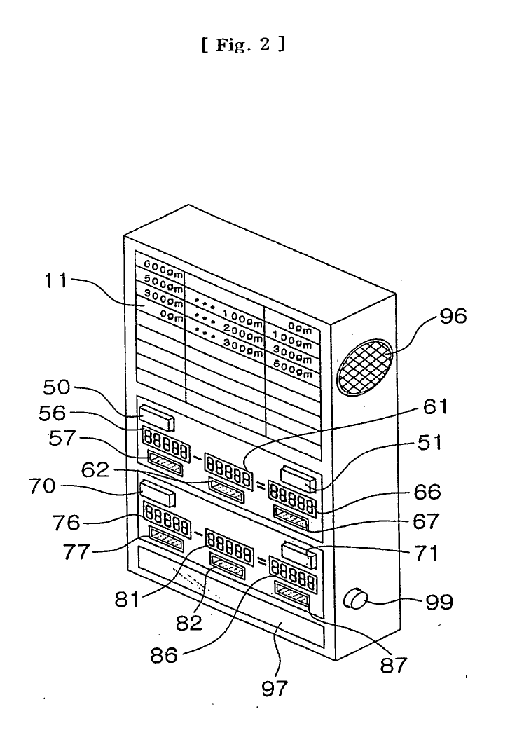

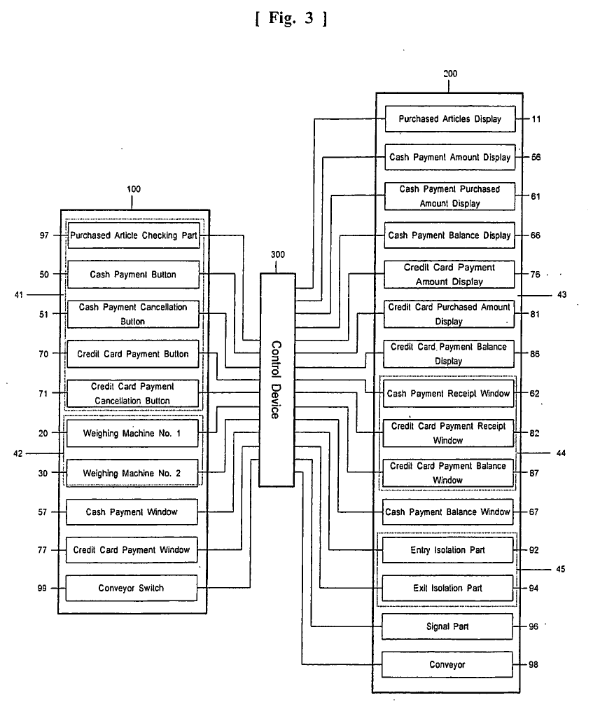

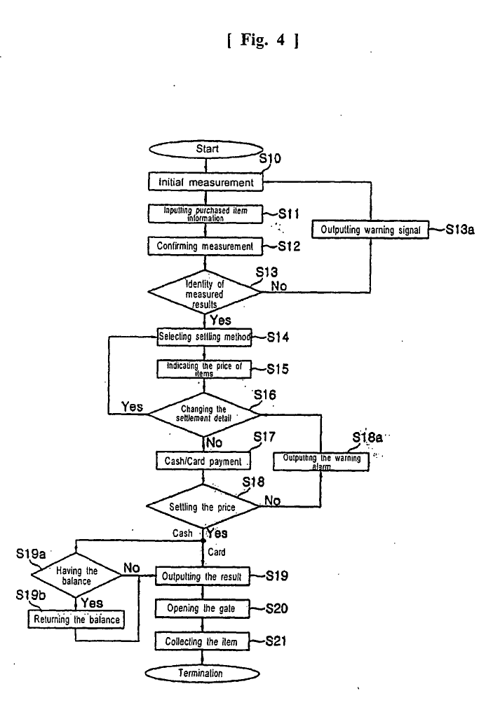

### TECHNOLOGY

In general, the purchaser in a large shop shows the bought articles to accounting clerk, and pays for the articles as suggested by the clerk. But this process has much to be renovated due to its inconvenience.

### DETAILED DESCRIPTION OF THE INVENTION

### Technological Tasks

This invention enables the purchaser to calculate the price of articles and pay for the articles himself so that the shop may be operated without the help of accounting clerk.

### Technological Solution

This invention is related to automatic payment calculation board. It is composed of
Input device (100) which is composed of
purchased article check part (97) where the article information is inputted by bar-code,
Button Input Part (41) which is composed of buttons to select the payment stage,
Weight Measurement Part (42) to check article weight,
Cash Payment Window(57) and Credit Card Payment Window (77) to receive cash or credit card, and
Conveyor switch (99) on the one side of calculation board (10)

### Button Input Part (41) is Equipped With

Cash Payment Button (50) and Credit Card Payment Button (70), as well as
Cash Payment Cancellation Button(51) and Credit Card Payment Cancellation Button (71)

### Weight Measurement Part (42) Consists of

Weighing Machine No. 1 (20) on the left side of calculation board and Weighing Machine No. 2 (30) on the right side of calculation board

### Output Device (20) of Calculation Board (10) is Equipped With

Display part (43) where article information and payment stages are displayed
Output Part (44) where the receipts are printed out
Isolation Part (45) which controls entry gates of calculation board,
Cash Payment Balance Window (67) to return the changes
Signal Part (96) on one side of calculation board to give alarm, and
Conveyor (98) in front of the calculation board

### Display Part (93) is Composed of

Purchased Articles Display (11) where the name, specification, numbers, unit price, and amount of purchased article as well as the weights measured by Weighing Machine No. 1 (20) and Weighing Machine No. 2 (30) are displayed,
Cash Payment Purchased Amount Display (61) which displays the purchased amount in case of cash payment
Cash Payment Amount Display (56), where the amount of cash put through Cash Payment Window (57)
Cash Payment Balance Display (66) where the balance is displayed
Credit Card Purchased Amount Display (81) for credit card payment
Credit Card Payment Amount Display (76) where the amount of money put through Credit Card Payment Window(77) are displayed
Credit Card Payment Balance Display (86) where the settled balance is displayed

### Output Part (44) Consists of

Cash Payment Receipt Window (62) where the receipts are printed out in case of case cash payment by Cash Payment Window (57)
Credit Card Payment Window(77) where the receipts are printed out in case of case credit card payment by Credit Card Payment Window (57), and
Credit Card Payment Balance Window(87), where the balance amounts of credit card are printed out

### Isolation Part Which Controls Electronically Gates Consists of

entry gate closing part (92) which controls entry gate
exit gate closing part (92) which controls exit gate

The information from input device (100) is compared and verified by control device (300) in line with the functions of output device (200) elements for automatic payment calculation.

### Expected Benefits

This invention enables the purchaser of the shop to calculate the prices and pay for the articles by himself using the automatic calculating board so that the shop may be operated without accounting clerks.

### BRIEF DESCRIPTION OF THE DRAWING

Drawing 1 Perspective view, Example(1) of calculation board of this Invention

Drawing 2 Component Perspective view, Example(1) of calculation board of this Invention

Drawing 3: Component Block Diagram, Example(1) of calculation board of this Invention

Drawing 4 Control Flow Diagram, Example(1) of calculation board of this Invention

### DESCRIPTION OF DRAWING SIGNS

10 : Calculation Board

11 : Purchased Articles Display

20 : Weighing Machine No. 1

30 : Weighing Machine No. 2

40 : Bar-code

41 : Button Input Part

42 : Weight Measurement Part

43 : Display Part

44 : Output Part

45 : Isolation Part

50 : Cash Payment Button

51 : Cash Payment Cancellation Button

56 : Cash Payment Amount Display

57 : Cash Payment Window

61 : Cash Payment Purchased Amount Display

62 : Cash Payment Receipt Window

66 : Cash Payment Balance Display

67 : Cash Payment Balance Window

70 : Credit Card Payment Button

71 : Credit Card Payment Cancellation Button

76 : Credit Card Payment Amount Display

77 : Credit Card Payment Window

81 : Credit Card Purchased Amount Display

82 : Credit Card Payment Receipt Window

86 : Credit Card Payment Balance Display

87 : Credit Card Payment Balance Window

91 : Entry Gate

92 : Entry Isolation Part

93 : Exit Gate

94 : Exit Isolation Part

96 : Signal Part

97 : Article Information Checking Part

98 : Conveyor

99 : Conveyor Switch

100 : Input Device

200 : Output Device

300 : Control Device

### INDUSTRIAL UTILIZATION

The following is the process of the system, when the purchaser comes into the entry gate (93) until he goes out of the calculation board through exit gate (93);
The purchase comes into the calculation board through entry gate where Entry Isolation Part(92) has been opened and then puts the S10 articles on the Weighing machine No. 1. Then the weight of the articles are transferred to control device (300), and the calculation boards becomes ready to settle the payment amount by inputting the information on the articles purchased. Then the purchaser can verify the article weight through Purchased Articles Display(11). In S11 stage “Purchased Article Information Input”, the purchaser touches the bar-code (40) of the articles to Article Information Check Part (97) to input the article information to control device (300). After control device (300) received the weights from Weighing Machine No. 1, it displays them in orderly manner on one side of Purchased Articles Display(11) so that they can be verified by the purchaser. In addition the control device also displays product name, specifications, unit price, amount, total amount, etc in orderly manner on one side of Purchased Articles Display (11), after receiving such information from Purchased Article Information Check Part (97). During S12 stage verification measurement of purchased articles, the purchased articles are transported to Weighing Machine No. 2 (30). Then, control device displays the weight measured by Weighing Machine No. 2 (30) on the other side of Purchased Article Display (11), so that the purchaser could compare them. When all purchased articles are transferred to Weighing Machine No. 2 (30) from Weighing Machine No. 1 (20), after repeating S11 stage and S12 stage, control device (300) compares the purchased article weight measured by Weighing Machine No. 1 (20) with that by Weighing Machine No. 1 (20). If the weighted values are not same, control device (300) gives alarm through Signal Part (96) in S13a stage, Alarm Signal Generation. And If the values are the same, it asks the purchaser to select the payment method (by cash or credit card through Cash Payment Button (50) or Credit Card Payment (70)) in S14 stage, payment method selection. In S15 stage, Purchased Article Amount Display, control device displays the amount on Cash Payment Purchased Amount Display (61) or Credit Card Purchased Amount Display(81), so that the purchaser can verify the amount. In S 16 stage, Payment Method Change Decision, the purchaser can change payment method. If the payment method is changed, control device rewind the process to S14 stage. But if the payment method is not changed, the purchaser is introduced to make payment through Cash Payment Window (57) and Credit Card Payment Window (77) in S17 stage. Control device displays cash payment through Cash Payment Window (56) on Cash Payment Amount Display (56) and credit card payment through Credit Card Payment Window (77) on Credit Card Payment Amount Display (76) for verification. In S18 stage, Purchased Articles Payment Decision, it compares the purchase amount and paid amount for settlement. If there is no need for settlement. If the payment cannot be made by the payment method which the purchaser selected, control device (300) will give alarm signal through Alarm Signal Creation and return to S16 stage so that the purchase can change payment method. If the payment is made by cash, and the paid amount can cover the purchased amount, the system checks whether it has sufficient change in S19a stage and, if so, control device (300) will return the change through Cash Payment Balance Window (67), and according to the payment method opted for by the purchaser, in case of no balance being remained at the stage of S19a, or the balance being cashed through S19b, or the account being supposed to be settled by the payment amount at S18, the control device (300) completes the payment and prints out the receipts through Cash Payment Receipt Window (62) in case of cash payment or receipts and card balance sheet through Credit Card Payment Receipt Window(87) and Credit Card Payment Balance Window(87). After receipts are printed out in order, control device (300) allows the purchaser to pass through exit gate by controlling Exit Isolation Part (94) in S20 stage, Exit Open. In S21 stage, the control process ends as the purchaser puts the articles from Weighing Machine No. 2(30) and pass through the exit gate (93). And then, control device (300) controls power so that the payment is additional payment cannot made. After the purchaser went out through exit gate (93) by exit Isolation Part (94), control device closes the exit gate and open the entry gate by controlling the entry Isolation Part (92) so that another purchaser can approach calculation board (10). And all of the above process will be repeated.

1. The automatic calculator unit which consists of
Article Information Checking Part where the article information is inputted by bar-code
Input device (100) composed of Button Input Parts to select stages for the calculation of payment amount
Display Part where the inputted article information and stage information are displayed
Output Device which is composed of Output Parts to print out receipts and others
Control Device which controls output device (200) after comparing the information with that from input device (100)
Input device (100) is composed of
Weight Measure Part which is composed of Weighing Machine No. 1 on the left side of calculation board to check the weight of purchased articles and Weighing Machine No. 2 to check the weight of purchased articles, and
Cash Payment Window and Credit Card Payment Window
Output device (100) is composed of
Cash Payment Balance to refund changes after receipt of cash, and
Entry Isolation Part and Exit Isolation Part to open or close the entry and exit gates
Control Device (300) checks there the weight measured at Weighing Machine No. 1 and that measured at Weighing Machine No. 2 is the same. It also controls entry and exit gates so that the purchaser can pass through and another purchaser can gen into.

2. The automatic calculator which enables the purchaser to make payment after the purchased articles are put on Weighing Machine No. 1 and to prevent the purchaser from payment after the articles are removed from Weighing Machine No. 2 after previous payment through the control device.

3. The automatic calculator which is characterized by
The input system which is equipped with conveyor switch used for the transport of the purchased articles.
The output system which is equipped with conveyor at the front and Signal part at the side which gives alarm when the weight measured by Weighing Machine No. 1 and that by Weighing Machine No. 2 are different each other, as controled by control device.
